(19) United States
(12) Patent Application Publication
(10) Pub. No.: US 2026/0351600 A1
(43) Pub. Date: Nov. 5, 2026

(54) DISPERSANT FOR LITHIUM IRON PHOSPHATE

(71) Applicant: BYK-Chemie GmbH, Wesel (DE)

(72) Inventors: Robin von Hagen, Dusseldorf (DE); Yuli Simon Wang, Shanghai (CN); Megumu Takai, Hyogo (JP); Yu Sugioka, Osaka (JP); Yuji Kanafusa, Hyogo (JP); Stephan Feser, Wesel (DE)

(21) Appl. No.: 19/119,907

(22) PCT Filed: Nov. 6, 2023
(86) PCT No.: PCT/EP2023/080845

§ 371 Date: Apr. 10, 2025

(30) Foreign Application Priority Data
Nov. 9, 2022 (WO) PCT/CN2022/130849
Dec. 13, 2022 (EP) 22213213.6

(51) Int. Cl. H01M 4/58; H01M 4/02; H01M 4/36; H01M 4/583; H01M 4/62

(52) U.S. Cl. CPC H01M 4/5825; H01M 4/366; H01M 4/583; H01M 4/622; H01M 4/625; H01M 2004/021; H01M 2004/028

(57) ABSTRACT

The invention relates to a composition comprising a) a lithium iron phosphate-based positive electrode active material, and b) an essentially linear polymer or oligomer having at least one acidic phosphoric acid ester group.

The invention relates to a composition comprising a lithium iron phosphate-based positive electrode active material and an essentially linear polymer or oligomer, to a positive electrode for a battery comprising the composition, to a battery comprising the positive electrode, to the use of an essentially linear polymer or oligomer for reducing the viscosity of a slurry comprising particles of a lithium iron phosphate-based positive electrode active material, and to a process of preparing an electrode slurry for a battery.

US 2020/0028174 A describes lithium iron phosphate electrode materials with hydrogenated nitrile butadiene rubber as dispersant.

CN 103545527 A describes a battery slurry dispersant for Li ion batteries. The dispersant is a copolymer of acrylic acid, maleic anhydride, (hydroxyethyl)methacrylate phosphate, and allyl-functional polyethylene oxide macromonomer. The dispersant has a comb polymer structure. It is prepared in an aqueous environment and comprises lithium carboxylate groups.

CN 102237521 A describes tartrate salts as dispersants for Li ion battery slurries. Preferably the tartrate is used in combination with citrate.

JP 2014 149968 A describes aqueous slurries for battery electrodes comprising lithium iron phosphate, a water-soluble polymer, and a dispersing agent. The dispersing agent is a salt, for example a lithium salt, sodium salt, potassium salt, ammonium salt, and organic amine salt, of a linear polymer or oligomer having a phosphoric acid ester.

There is an ongoing need to further improve compositions comprising lithium iron phosphate-based positive electrode active material suitable for preparing an electrode for a rechargeable battery, in particular in view of the compositions having a desirable low viscosity, a good stability of the dispersion, and further provides a desirable electrochemical stability of the rechargeable battery and a low volume resistivity of the resulting electrode.

The Invention provides a composition comprising
a) a lithium iron phosphate-based positive electrode active material, and
b) an essentially linear polymer or oligomer having at least one acidic phosphoric acid ester group.

The composition according to the invention is very suitable for use in compositions for preparing an electrode for a rechargeable battery. The composition has a desirable low viscosity, a good stability of the dispersion, and further provides desirable electrochemical properties of the rechargeable battery, and a low volume resistivity of the resulting electrode One important advantage over other lithium-ion chemistries is thermal and chemical stability, which improves battery safety.

Lithium iron phosphate-based positive electrode active materials are known in the art.

The lithium iron phosphate-based positive electrode active material may be represented by the following Formula I:

Li₁₊ₐFe₁₋ₓMₓPO_{4-b}A_{b}

In Formula, M represents at least one from the group consisting of manganese (Mn), nickel (Ni), cobalt (Co), copper (Cu), scandium (Sc), titanium (Ti), chromium (Cr), vanadium (V), and zinc (Zn), A represents at least one selected from the group consisting of sulfur (S), selenium (Se), fluorine (F), chlorine (Cl), and iodine (I), a is in the range of −0.5 to 0.5, x is in the range of 0.0 to 0.5, and b is in the range of 0.0 to 0.1.

In some embodiments, the lithium iron phosphate-based positive electrode active material is represented by the formula LiFePO₄. It is a natural mineral of the olivine family (triphylite). LiFePO₄ was identified as a cathode material belonging to the polyanion class for use in batteries. Because of its low cost, non-toxicity, the natural abundance of iron, its excellent thermal stability, safety characteristics, electrochemical performance, and specific capacity it has gained considerable market acceptance.

Commercial lithium iron phosphate-based positive electrode active materials are usually synthetic materials. The synthesis methods of lithium iron phosphate materials mainly include solid phase methods and liquid phase methods. The solid phase methods include high temperature solid phase reaction method, carbothermal reduction method, microwave synthesis method, and mechanical alloying method. The solid phase synthesis method is the most commonly used method for preparing electrode materials because of its simple process and easy industrialization. The carbothermal reduction method is the most common solid-phase method. In the carbothermal reduction method inexpensive ferric iron is reduced to ferrous iron by an organic carbon precursor compound, such as citric acid, and at the same time, the pyrolytic carbon is coated on the lithium iron phosphate to enhance the electrical conductivity.

The liquid phase methods include liquid phase precipitation method, sol-gel method, and hydrothermal synthesis method. Taking the hydrothermal method as an example, using water as a solvent in a sealed pressure vessel, the raw material undergoes a chemical reaction under high-temperature and high-pressure conditions, and the nano-precursor is obtained after filtration, washing, and drying, and finally can be calcined at high temperature. Lithium iron phosphate is obtained. The liquid phase preparation methods generally lead to lithium iron phosphate-based materials having a narrower particle size distribution.

The lithium iron phosphate-based positive electrode active material is a structurally very stable positive electrode active material, but is disadvantageous in that electrical conductivity and ionic conductivity are low. Thus, the lithium iron phosphate-based positive electrode active material is preferably used in such a manner that the electrical conductivity is improved by coating the surface of the lithium iron phosphate-based positive electrode active material with carbon, and the ionic conductivity is improved by reducing a particle size of the lithium iron phosphate-based positive electrode active material.

In view of the above, in the composition according to the invention the surface the lithium iron phosphate-based material is at least partially coated with an electrically conductive carbon-based material. In further preferred embodiments, the carbon content of the lithium iron phosphate-based material is in the range of 0.4 to 2.0% by weight, preferably 0.5 to 1.7% by weight, calculated on the weight of the lithium iron phosphate-based material.

In a further preferred embodiment, the lithium iron phosphate-based material is present in the form of particles having an average particle size D50 in the range of 100 to 5000 nm, more preferably 200 to 4000 nm. The particle size can suitably be determined using laser diffraction, using the Mie theory of light scattering. The particle size is reported as a volume equivalent sphere diameter.

The composition of the invention further comprises an essentially linear polymer or oligomer having at least one acidic phosphoric acid ester group. The polymer or oligomer is essentially linear. Essentially linear means the essential or complete absence of polymeric branches covalently linked to the polymer or oligomer main chain. Generally, the polymer or oligomer is considered essentially linear when the linear main chain comprises 90 to 100% by weight of the polymer weight. The polymer or oligomer comprises at least two, preferably at least three repeating units of polymerized monomers. Generally, the polymer or oligomer comprises 3 to 500 repeating units of polymerized monomers. The polymer or oligomer may be based on one or more types of monomers.

In preferred embodiments, the essentially linear polymer or oligomer comprises ether repeating units. The oligomer or polymer may be a polyether, for example a polyether prepared by ring opening polymerization of cyclic ether groups, such as epoxides, oxetanes, and oxolanes. Examples of suitable epoxides include ethylene oxide, propylene oxide, glydicylethers, glycidylesters, and mixtures thereof. Suitable oxetanes include unsubstituted oxetane or a substituted oxetane, such as trimethylolpropane oxetane.

In further preferred embodiments, the essentially linear polymer or oligomer comprises ester repeating units. The oligomer or polymer may be a polyester, for example a polyester based on dicarboxylic acids, diols, and optionally monoalcohols, monocarboxylic acids, and combinations thereof. Alternatively, polymers containing ester groups can be prepared by ring-opening polymerization of lactones. Examples of suitable lactones include epsilon-caprolactone and delta-valerolactone.

In a further embodiment, the polymer or oligomer comprises ester groups and ether groups. In one embodiment, the polymer may be a block copolymer comprising at least one polyether block and at least one polyester block. Alternatively, ester groups and ether groups may be distributed randomly.

The essentially linear polymer or oligomer b) preferably has a number average molecular weight in the range of 250 to 5000 g/mol, more preferably in the range of 250 to 4000 g/mol, and even more preferably in the range of 250 to 3500 g/mol.

The number-average molecular weight Mn and the weight-average molecular weight Mw are suitably determined in accordance with DIN 55672-1:2007-08 by means of gel permeation chromatography using tetrahydrofuran as eluent and polystyrene as calibration standard.

The essentially linear polymer or oligomer comprises at least one acidic phosphoric acid ester group. An acidic phosphoric acid ester group is present in monoesters and diesters of phosphoric acid.

The number of acidic phosphoric acid ester groups may be different in individual polymer or oligomer molecules. Some individual molecules may have a plurality of acidic phosphoric acid ester groups. It is also possible, that the polymer or oligomer comprises individual molecules having no acidic phosphoric acid ester group.

In exemplary embodiments, the essentially linear polymer or oligomer has an average number of acidic phosphoric acid ester groups per molecule in the range of 0.8 to 4.0, preferably 0.8 to 2.5, most preferably in the range of 0.8 to 2.1.

In exemplary embodiments, the acidic phosphoric acid ester groups are terminal groups of the essentially linear polymer or oligomer. In some embodiments, the essentially linear polymers or oligomers have one terminal acidic phosphoric acid ester group. In these embodiments, the other terminal group can be a hydroxyl group, or an alkyl ester or alkyl ether group. In further embodiments, both terminal groups of the essentially linear polymer or oligomer are acidic phosphoric acid groups. In a still further embodiment, the essentially linear polymer or oligomer has two acidic phosphoric acid ester groups at one terminus, and no or one acidic phosphoric acid ester groups at the other terminus. In some embodiments, an acidic phosphoric acid ester group may be located along the polymer chain or may interrupt the polymer chain.

It is generally preferred that the essentially linear polymer or oligomer has a low content of carboxylic acid groups or salts thereof. In particularly preferred embodiments, the essentially linear polymer or oligomer is free or essentially free of carboxylic acid groups or salts thereof. Therefore, the essentially linear polymer or oligomer preferably has an average number of carboxylate and carboxylic acid groups per molecule in the range of 0.0 to 2.0, preferably 0.0 to 0.5.

The essentially linear polymer or oligomer having at least one acidic phosphoric acid ester group is suitably prepared by reaction of a hydroxyl functional polymeric or oligomeric precursor with an ester-forming phosphorous compound. An ester-forming phosphorus compound is understood to be a compound capable of forming phosphoric acid ester by reaction with a compound that contains hydroxyl groups. Examples of ester-forming phosphorus compounds include polyphosphoric acid, phosphorus pentoxide, phosphoryl chloride and acetyl phosphate. Special substitution patterns may occur when using special phosphorylation agents in particular, for example, phosphoryl chloride. Polyphosphoric acid and phosphorus pentoxide are preferred, but polyphosphoric acid is especially preferred. Mainly monoesters are formed with polyphosphoric acid and monoester/diester mixtures are formed with phosphorus pentoxide. The monoesters are preferred. It is also possible that a mixture of various components to be phosphorylated is used in the phosphorylation reaction. Reaction of the ester-forming phosphorus compounds with the hydroxyl compounds preferably takes place in the absence of a solvent at temperatures up to 150 °C, preferably below 100 °C. However, the reaction may also be performed in the presence of suitable inert solvents, for example methoxypropyl acetate.

The weight ratio of the lithium iron phosphate-based positive electrode active material to the essentially linear polymer or oligomer having at least one acidic phosphoric acid ester group can vary in wide ranges. In typical embodiments, the amount of polymer or oligomer b) is in the range of 0.01 to 5.00% by weight, preferably 0.05 to 3.00% by weight, calculated on the sum of the weight of components a) and b).

In exemplary embodiments, the composition of the invention comprises a single type of essentially linear polymer or oligomer having at least one acidic phosphoric acid ester group. However, in some embodiments it has been found advantageous in terms of viscosity reduction to use a combination of two or more types of essentially linear polymer or oligomer having at least one acidic phosphoric acid ester group. The different types of oligomer or polymer may differ in the type of polymer backbone, molecular weight, or the average number of acidic phosphoric acid groups.

In some embodiments, it may be advantageous to include in the composition a further polymeric dispersant, which is different from the essentially linear polymer or oligomer having at least one acidic phosphoric acid ester group. Such further polymeric dispersant may facilitate the dispersion of the lithium iron phosphate-based positive electrode active material, or of other particles present in the composition, such as electrically conductive carbon-based materials.

In preferred embodiments, the composition of the invention is a liquid or in the form of a paste at a temperature of 20 °C. In order to render the composition liquid or paste-like, the composition preferably comprises one or more solvents. The solvent may be an organic solvent or water. In preferred embodiments, the composition is a non-aqueous composition. A non-aqueous composition is a composition wherein water is not the primary liquid diluent. A non-aqueous composition generally has a low content of water or does not contain any intentionally added water at all. Suitably, the water content of a non-aqueous composition is in the range of 0 to 10% by weight, preferably 0 to 5% by weight, calculated on the weight of the composition. Generally, an organic solvent is selected that is capable of dissolving the polymeric or oligomeric components of the composition. The organic solvent may also comprise more than one type of organic solvent, for example a mixture of two or more types of solvents. Examples of suitable solvents include ester solvents, such as methyl acetate, ethylacetate, γ-butyrolactone, and ε-caprolactone; an ether-based solvent such as dibutyl ether or tetrahydrofuran; a ketone-based solvent such as cyclohexanone; an aromatic hydro-carbon-based solvent such as benzene, toluene, and fluorobenzene; or a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R-CN (where R is a linear, branched, or cyclic C2-C20 hydrocarbon group and may include a double-bond aromatic ring or ether bond); amides such as dimethylformamide; dioxolanes such as 1,3-dioxolane; or sulfolanes may be used as the organic solvent. Examples of further suitable solvents include aprotic dipolar solvents, such as dimethyl sulfoxide, dimethyl formamide or N-methyl pyrrolidone, or other solvents comprising an amide group. In the case of using water as a solvent, it may be preferred to use further include a thickener. The amount of the solvent is adjusted to obtain a viscosity at which a paste can be applied to a collector easily.

Generally, the organic solvent is present in the composition of the invention in an amount of 10 to 90% by weight, calculated on the total weight of the composition.

In a further embodiment, the organic solvent is present in an amount of 15.0 to 60.0% by weight, calculated on the sum of the weight of components a) and b).

In another embodiment, the composition further comprises an organic polymeric binder which is different from component b). The binder improves the adhesion between the positive electrode active material particles and the adhesion between the positive electrode active material and a current collector. Examples of the binder include known binders such as: fluorine-based polymers such as polyvinylidene fluoride, polyvinylidene fluoride-hexafluoropropylene copolymer, and polytetrafluoroethylene; rubber-based binders such as styrene-butadiene rubber (SBR), ethylene-propylene-diene monomer rubber (EPDM), a sulfonated EPDM, and a fluorine rubber; polyethylene; polypropylene; polyvinyl alcohol; polyvinylpyrrolidone, polyacrylonitrile; carboxymethyl cellulose (CMC); starch; hydroxypropyl cellulose; regenerated cellulose; and binders based on polyacrylates. If so desired, the binder may be used in the form of an aqueous dispersion.

A suitable use amount of the binder is 1.0 to 50.0 parts by mass in terms of 100 parts by mass of the non-volatile material of the composition, and in particular, the used amount is preferably about 1.0 to 20.0, more preferably 1.0 to 10.0 parts by mass.

To increase the electrical conductivity of the electrode material, the composition may further comprise an electrically conductive carbon material. A carbon-based material is a material which consists for 90 to 100% by weight of carbon. For use in the field of electrode manufacture for batteries, a carbon-based material is selected which is electrically conductive. Examples of suitable electrically conductive carbon-based materials include carbon black, carbon nano tubes, graphite, carbon fibers, graphene, fullerenes, and mixtures thereof. Preferred carbon-based materials are carbon black, graphene, and carbon nano tubes. Specific types of suitable carbon black are furnace black and acetylene black.

In a further embodiment, the invention also relates to a positive electrode for a battery, wherein the electrode comprises the composition of the invention.

The expression battery encompasses a single electrochemical cell that contains a positive electrode and a negative electrode, a separator disposed between the positive electrode and the negative electrode, and an electrolyte. The expression battery also encompasses a collection of multiple electrochemical cells or cell assemblies.

The terms positive electrode or cathode designate the electrode where reduction is taking place during the discharge cycle.

The electrolyte suitably is a compound capable of providing lithium ion in the battery. Lithium salts are generally used. Specific examples of suitable lithium salts include LiPF₆, LiClO₄, LiAsF₆, LiBF₄, LiSbF₆, LiAlO₄, LiAlCl₄, LiCF₃SO₃, LiC₄F₉SO₃, LiN (C₂F₅SO₃)₂, LiN (C₂F₅SO₂)₂, LiN(CF₃SO₂)₂, LiCl, LiBr, LiI, or LiB(C₂O₄)₂. The lithium salt is generally used in a concentration range of 0.1 M to 2.0 M.

The composition is suitably used in the form of a paste. The paste for an electrode can be obtained by kneading the components of the composition. A known device such as a ribbon mixer, a screw-type kneader, a Spartan Granulator, a Loedige Mixer, a planetary mixer, or a universal mixer may be used for kneading. The paste for an electrode may be formed into a sheet shape, a pellet shape, or the like.

An electrode may be formed of a molding of the above-mentioned paste for an electrode. The electrode is obtained, for example, by applying the paste for an electrode to a collector, followed by drying and pressure molding.

Examples of the collector include foils and mesh of aluminum, nickel, copper, stainless steel and the like. The coating thickness of the paste is generally 40 to 200 μm. There is no particular limitation to the paste coating method, and an example of the coating method includes a method involving coating with a doctor blade or a bar coater, followed by molding with roll pressing or the like.

Examples of the pressure molding include roll pressure molding, compression molding, and the like. The pressure for the pressure molding is preferably about 1 to 3 t/cm². As the density of the electrode increases, the battery capacity per volume generally increases. However, if the electrode density is increased too much, the cycle characteristic is generally degraded. If the paste for an electrode in a preferred embodiment of the present invention is used, the degradation in the cycle characteristic is small even when the electrode density is increased. Generally, the electrode density is in the range of 1.0 to 4.0 g/cm³. In some embodiments, the electrode density of a cathode is in the range of 2.0 to 3.5 g/cm³, and the density of an anode is in the range of 1.2 to 2.0 g/cm³.

As mentioned above, it has been found that the presence of an essentially linear polymer or oligomer having at least one acidic phosphoric acid ester group in an electrode slurry comprising a lithium iron phosphate-based positive electrode active material, effectively reduces the viscosity of the slurry. This facilitates handling of the slurry, without the need to add large amounts of viscosity reducing solvent.

Therefore, in a further aspect, the invention also relates to the use of an essentially linear polymer or oligomer having at least one acidic phosphoric acid ester group for reducing the viscosity of a slurry comprising particles of a lithium iron phosphate-based positive electrode active material. The invention also relates to a method of reducing the viscosity of a slurry comprising particles of a lithium iron phosphate-based positive electrode active material, the method comprising the step of including an essentially linear polymer or oligomer having at least one acidic phosphoric acid ester group into the slurry.

In a still further embodiment, the invention relates to process of preparing an electrode slurry for a battery, comprising the steps of
i) Providing a lithium iron phosphate-based positive electrode active material,
ii) Providing a solvent,
iii) Providing an essentially linear polymer or oligomer having at least one acidic phosphoric acid ester group,
iv) Providing an organic polymeric binder which is different from the essentially linear polymer or oligomer having a terminal phosphoric acid ester group,
v) Mixing the components provided in steps i) to iv) in any suitable order.

### EXAMPLES

### Raw Materials

All raw materials were purchased from Sigma-Aldrich (Merck) unless otherwise indicated.
Methoxy poly(ethylene glycol) Mw 350 (MPEG 350)
Methoxy poly(ethylene glycol) Mw 500 (MPEG 500)
ε-Caprolactone
γ-Valerolactone
4-Dodecylbenzenesulfonic acid (DBSA)
Isodecanol
Poly phosphoric acid (PPA)
Phosphorous pentoxide (P₂O₅)
Dibutyltin dilaurate (DBTL)
2-Ethylhexyl glycidylether (EHGE)
Trifluoromethanesulfonic acid (TFMSA)
N-methyl-2-pyrrolidone (NMP)
K-Kat XK-633 (zinc catalyst)—King Ind.
Emulsogen TS 100 (tristyrylphenol ethoxylate)—Clariant
Makon-TD 8 (tridecyl alcohol ethoxylate)—Stepan
Lutensol AT50 (C16-C18-fatty alcohol ethoxylate)—BASF
Pluronic RPE 1740 (EO-PO block polyether)—BASF
DY-3 Lithium iron phosphate based material (LFP)—Dynanonic
YN-5 Lithium iron phosphate based material (LFP)—Yuneng
Super P (carbon black)—Imerys
Kynar HSV 900 (PVDF)—Arkema
Sokalan K30 (PVP)—BASF
HNBR (Arlanxeo)

### Preparation Methods for the Intermediate Products

### Preparation Method of Intermediate I-1 (MPEG-Started Polyester)

A clean dry four-necked flask (250 mL) with condenser, stirrer, temperature sensor and a nitrogen line was charged with MPEG 350 (50.06 g), ε-Caprolactone (32.43 g), γ-Valerolactone (18.39 g) and DBSA (0.11 g), heated up to 80 °C and stirred 3 h at this temperature.

### Preparation Method of Intermediate I-2 (Alcohol-Started Polyester)

A clean dry four-necked flask (250 mL) with condenser, stirrer, temperature sensor and a nitrogen line was charged with Isodecanol (14.35 g), ε-Caprolactone (85.55 g) and K-Kat XK-633 (0.10 g), heated up to 170 °C and stirred 3 h at this temperature.

### Preparation Method of Intermediate I-3 (Tristyrylphenol Ethoxylate-Started Polyester)

A clean dry four-necked flask (250 mL) with condenser, stirrer, temperature sensor and a nitrogen line was charged with Emulsogen TS 100 (55.76 g), ε-Caprolactone (7.52 g), γ-Valerolactone (6.60 g) and DBTL (0.02 g) heated up to 170 °C and stirred 3 h at this temperature.

### Preparation Method of Intermediate I-4 (MPEG-Started Statistical Poly-Ester/Ether)

A clean dry four-necked flask (250 mL) with condenser, stirrer, temperature sensor and a nitrogen line was charged with MPEG 500 (54.55 g), ε-Caprolactone (24.91 g), 2-ethylhexyl glycidylether (20.51 g) and TFMSA (0.03 g) heated up to 80 °C and stirred 3 h at this temperature.

### General Preparation Method for Linear Phosphoric Acid Ester Functionalized Dispersants (P)

A clean dry four-necked flask (250 mL) with condenser, stirrer, temperature sensor and a nitrogen line was charged with component A (see table 1) and heated up to 50 °C. Then, the phosphorylation component B was slowly added to the mixture. After complete addition, the mixture was heated up to 80 °C and stirred 4 h at this temperature.

TABLE 1
Recipes of dispersant P-1-P-7

| Dispersant | Component A | wt. % | Component B | wt. % |
|---|---|---|---|---|
| P-1 | I-1 | 89.70 | PPS | 11.30 |
| P-2 | I-2 | 91.36 | PPS | 8.64 |
| P-3 | Lutensol AT50 | 95.97 | PPS | 4.03 |
| P-4 | Pluronic RPE 1740 | 93.70 | PPS | 6.30 |
| P-5 | Makon-TD 8 | 84.95 | P₂O₅ | 15.05 |
| P-6 | I-3 | 94.95 | PPS | 5.05 |
| P-7 | I-4 | 89.06 | PPS | 10.94 |

### General Preparation Method for LFP Cathode Standard Slurry (S1)

YN-5 (24.0 g), carbon black (0.15 g) and PVDF (0.5 g) were filled into a 250 mL plastic vessel and mixed at 2000 rpm for 10 min in a Hauschild SpeedMixer®. Then, dispersant (0.05 g) diluted in NMP (13.27 g) was added to the dry mixture and the slurry was further mixed at 2000 rpm for 20 min.

### General Preparation Method for LFP Cathode Standard Slurry (S2)

DY-3 (24.0 g), carbon black (0.15 g) and PVDF (0.5 g) were filled into a 250 mL plastic vessel and mixed at 2000 rpm for 10 min in a Hauschild SpeedMixer®. Then, dispersant (0.05 g) diluted in NMP (16.43 g) was added to the dry mixture and the slurry was further mixed at 2000 rpm for 20 min.

Preparation Method for LFP Cathode Standard Slurry without Dispersant (S2-0)

DY-3 (24.0 g), carbon black (0.15 g) and PVDF (0.55 g) were filled into a 250 mL plastic vessel and mixed at 2000 rpm for 10 min in a Hauschild SpeedMixer®. Then, NMP (16.43 g) was added to the dry mixture and the slurry was further mixed at 2000 rpm for 20 min.

### General Preparation Method for Conductive Slurry (S3)

Carbon black (1.05 g), PVDF (0.73 g), dispersant P (0.73 g) and NMP (30.83 g) were filled into a 250 mL plastic vessel and mixed at 2000 rpm for 20 min in a Hauschild SpeedMixer®.

Preparation Method for Conductive Slurry without Dispersant (S3-0)

Carbon black (1.48 g), PVDF (1.02 g) and NMP (30.83 g) were filled into a 250 mL plastic vessel and mixed at 2000 rpm for 20 min in a Hauschild SpeedMixer®.

### Viscosity Measurement

LFP cathode slurries (S1/S2) were initially stored at room temperature for one hour. The rheology of the slurries was evaluated with an Anton Paar MCR rheometer at a measurement temperature of 25 °C and a cone plate CP-50 according to the following protocol:

TABLE 2
Viscosity measurement protocol

| | | | | Viscosity |
|---|---|---|---|---|
| Step | Constant shear rate | Period | Total | detection |
| 1 | 1 s⁻¹ | 20 s | 20 s | — |
| 2 | 0.01 s⁻¹ | 60 s | 80 s | V1 @ 80 s |
| 3 | 1000 s⁻¹ | 60 s | 140 s | V2 @ 140 s |
| 4 | 0.01 s⁻¹ | 120 s | 260 s | V3 @ 260 s |

TABLE 3
Viscosities and recovery rates V3/V1 of LFP slurries

| | | | V1 | V2 | V3 | V3/V1 × |
|---|---|---|---|---|---|---|
| Slurry | LFP | Dispersant | (mPas) | (mPas) | (mPas) | 100 |
| S1-1* | DY-3 | PVP | 173740 | 444.32 | 36723 | 21.14% |
| S1-2 | DY-3 | P-1 | 75948 | 325.61 | 43246 | 56.94% |
| S1-3 | DY-3 | P-2 | 46107 | 274.72 | 30155 | 65.40% |
| S1-4 | DY-3 | P-3 | 73886 | 293.63 | 50576 | 68.45% |
| S1-5 | DY-3 | P-4 | 61454 | 290.34 | 38090 | 61.98% |
| S1-6 | DY-3 | P-5 | 55430 | 249.06 | 24691 | 45.54% |
| S1-7 | DY-3 | P-6 | 70551 | 306.83 | 40954 | 58.05% |
| S1-8 | DY-3 | P-7 | 54692 | 274.47 | 31885 | 58.30% |
| S2-1* | YN-5 | PVP | 287970 | 875.79 | 109710 | 38.10% |
| S2-2* | YN-5 | HNBR | 204730 | 684.04 | 155410 | 75.91% |
| S2-3 | YN-5 | P-1 | 116790 | 653.21 | 88006 | 75.35% |
| S2-4 | YN-5 | P-2 | 57686 | 515.25 | 47114 | 81.67% |
| S2-5 | YN-5 | P-3 | 156390 | 664.47 | 83313 | 53.27% |
| S2-6 | YN-5 | P-4 | 91939 | 719.78 | 65184 | 70.90% |
| S2-7 | YN-5 | P-5 | 124560 | 759.93 | 79716 | 64.00% |
| S2-8 | YN-5 | P-6 | 112160 | 669.81 | 71642 | 63.87% |
| S2-9 | YN-5 | P-7 | 102750 | 678.37 | 64015 | 62.30% |

### Comparative Examples are Marked by *

From Table 3 it can be inferred that all LFP slurries according to the invention have lower viscosities than the comparative LFP slurries. This allows the formulation of slurries according to the invention with a given target viscosity using a lower amount of solvent.

The LFP slurries exhibit a thixotropic behavior. The viscosity of the slurries decreases upon exposure to shear force. This is indicated by the viscosity values V2 in Table 3 above. During the process of electrode manufacture from the slurries it is advantageous when the viscosity of the slurry increases when the slurry has been applied and when shear force is absent. Thus, a recovery of the viscosity after the end of exposure to shear force is highly desirable. The recovered viscosity is indicated by the viscosity values V3 in Table 3 above. The recovery of the viscosity is expressed as a quotient of the viscosities V3/V1. The LFP slurries of the invention show a high recovery of the viscosity. In particular, the LFP slurries according to the invention show an improved balance of low initial viscosity and good recovery.

### Measurement of the Volume Resistivity

LFP slurries were coated onto a PET sheet by doctor blading. After drying, the sheet was cut into pieces with 3 cm edge length and the volume resistivity of the formed electrode layer was measured with a four point probe and a low resistivity meter (Loresta-AX) meter at 25 °C.

TABLE 4
Volume resistivity of the electrode layers from
different LFP slurries of the electrode

| | | resistivity of the |
|---|---|---|
| Slurry | Dispersant Volume | electrode layer (Ω cm) |
| S2-0* | none | 366 |
| S2-3 | P1 | 297 |
| S2-7 | P5 | 298 |

Evaluation of Electrochemical Stability Conductive slurries (S3) were coated onto a copper and aluminum foil, respectively. After drying, the conductive layers were cut to circular electrodes with a diameter of 18 mm to assemble model cells with separators made from a glass fiber (EL-CELL product, model No. ECC1-01-0012-C/L). Lithium metal was used as anode material. A solution of 1 mol LiPF₆ dissolved in ethylene carbonate and propylene carbonate (1:1 vol % ratio) was prepared as electrolyte used for the test cells. Cyclic voltammetry (CV) of these test cells was measured from 2.5V to 4.8V vs Li/Li+ with the electrode layer on aluminum foil, and measured from 2.5V to 0.1V vs Li/Li+ with the electrode layer on copper foil. The scan speed was 0.05 mV/s. Three consecutive cycles were measured. The electrochemical stability of the dispersant was determined by comparing the CV curves of the electrodes with dispersant and without dispersant exhibiting no inherent hysteresis.

TABLE 5
CV of conductive slurries

| | | Cyclic voltammogram |
|---|---|---|
| Conductive Slurry | Dispersant | (0.1-4.8 V) |
| S3-0* | none | no hysteresis |
| S3-1 | P1 | no hysteresis |
| S3-2 | P5 | no hysteresis |

All CV curves showed no hysteresis in the applied voltage range indicating a good electrochemical stability of the dispersants.

1. A composition comprising
a) a lithium iron phosphate-based positive electrode active material, and
b) an essentially linear polymer or oligomer having at least one acidic phosphoric acid ester group.

2. The composition of claim 1, wherein the essentially linear polymer or oligomer comprises ether repeating units.

3. The composition of claim 1, wherein the essentially linear polymer or oligomer comprises ester repeating units.

4. The composition of claim 1, wherein the essentially linear polymer or oligomer b) has a number average molecular weight in the range of 250 to 5000 g/mol, determined in accordance with DIN 55672-1:2007-08 by means of gel permeation chromatography.

5. The composition of claim 1, wherein the essentially linear polymer or oligomer has an average number of acidic phosphoric acid ester groups per molecule in the range of 0.8 to 4.0, preferably 0.8 to 2.5.

6. The composition of claim 1, wherein the essentially linear polymer or oligomer has an average number of carboxylate and carboxylic acid groups per molecule in the range of 0.0 to 2.0.

7. The composition of claim 1, wherein the lithium iron phosphate-based material is present in the form of particles having an average particle size D50 in the range of 100 to 5000 nm, determined using laser diffraction.

8. The composition of claim 1, wherein the amount of polymer or oligomer b) is in the range of 0.01 to 5.00% by weight, calculated on the sum of the weight of components a) and b).

9. The composition of claim 1, wherein the composition further comprises one or more solvents.

10. The composition according to claim 9, wherein the one or more solvents are present in an amount of 15.0 to 60.0% by weight, calculated on the sum of the weight of components a) and b).

11. The composition of claim 9, wherein the one or more solvents are organic solvents.

12. The composition of claim 1, wherein the composition further comprises an organic polymeric binder which is different from component b).

13. The composition of claim 1, wherein the surface of the lithium iron phosphate-based material is at least partially coated with an electrically conductive carbon-based material.

14. The composition of claim 1, wherein the composition further comprises an electrically conductive carbon material.

15. The composition of claim 1, wherein the composition further comprises a polymeric dispersant, which is different from the essentially linear polymer or oligomer having at least one acidic phosphoric acid ester group.

16. A positive electrode for a battery, wherein the electrode comprises the composition of claim 1.

17. A battery comprising the positive electrode according to claim 16 and a negative electrode, a separator disposed between the positive electrode and the negative electrode, and an electrolyte.

18. (canceled)

19. A process of preparing an electrode slurry for a battery, comprising
i) Providing a lithium iron phosphate-based positive electrode active material,
ii) Providing a solvent,
iii) Providing an essentially linear polymer or oligomer having at least one acidic phosphoric acid ester group,
iv) Providing an organic polymeric binder which is different from the essentially linear polymer or oligomer having a terminal phosphoric acid ester group,
v) Mixing the components provided in steps i) to iv) in any suitable order.
